(19) United States
(12) Patent Application Publication
(10) Pub. No.: US 2021/0239406 A1
(43) Pub. Date: Aug. 5, 2021

(54) HEAT EXCHANGE ELEMENT AND HEAT EXCHANGE VENTILATION APPARATUS

(71) Applicant: Mitsubishi Electric Corporation, Tokyo (JP)

(72) Inventors: Akinori SHIMIZU, Tokyo (JP); Yoshihiro HOSOKAWA, Tokyo (JP); Shinya MORIKAWA, Tokyo (JP); Hajime SOTOKAWA, Tokyo (JP); Takahiro KAWASAKI, Tokyo (JP)

(73) Assignee: Mitsubishi Electric Corporation, Tokyo (JP)

(21) Appl. No.: 17/050,866

(22) PCT Filed: Jun. 1, 2018
(86) PCT No.: PCT/JP2018/021109

§ 371 Date: Oct. 27, 2020

(51) Int. Cl. F28D 21/00; F28D 9/00; F24F 7/08; F24F 12/00

(52) U.S. Cl. CPC F28D 21/0015; F28D 9/0037; F24F 12/006; F28D 21/0014; F24F 7/08; F28D 9/0068

(57) ABSTRACT

A heat exchange element includes a stack of a plurality of flow passage plates each including a plurality of passage portions serving as flow passages, the passage portions being bonded to each other by an adhesive tape; and a gap adjustment unit having a thickness equal to or larger than a thickness of an adhesive tape and is configured to fill a gap between the flow passage plates.

### TECHNICAL FIELD

The present disclosure relates to a heat exchange element and a heat exchange ventilation apparatus. In particular, the present disclosure relates to the structure of a counterflow type heat exchange element.

### BACKGROUND ART

In recent years, from a viewpoint of energy saving, a heat exchange ventilation apparatus has been adopted as an apparatus for ventilating a room. The heat exchange ventilation apparatus is a device that causes heat exchange to be performed between indoor air and outdoor air. In particular, a heat exchange element often causes temperature and humidity (hereinafter, collectively referred to as “total heat”) to be exchanged between indoor air and outdoor air. In order to reduce heat loss caused by ventilation, a paper unit having moisture permeability has been adopted as a heat exchange unit. Further, in order to improve heat exchange efficiency, a counterflow type heat exchange element in which supplied air and exhausted air flow in a face-to-face manner in a heat exchange section has been adopted.

For example, the counterflow type heat exchange element is manufactured by using a heat transfer body obtained by bonding a partition plate such as paper with a corrugated spacing plate such as paper. The spacing plate separates two fluids that exchange heat. The spacing plate forms a plurality of parallel flow passages. The heat exchange element has a counterflow passage portion in which the heat transfer body is cut out into a square shape, and a separated flow passage portion connected to both ends of the counterflow passage portion. The heat exchange element is formed by stacking a flow passage plate obtained by bonding with an adhesive tape the parallel flow passage portion and the separated flow passage portion.

### CITATION LIST

### Patent Literature

Patent Literature 1: WO/2016/147359

### SUMMARY OF INVENTION

### Technical Problem

Units forming the flow passage plate are bonded together with the adhesive tapes. Therefore, in the plate surface of the flow passage plate, portions where the adhesive tapes are attached protrude from the plate surface due to the thicknesses of the adhesive tapes as compared with the portion where no adhesive tapes are attached. When another flow passage plate is stacked on such flow passage plate, the distance between this passage plate and the other passage plate varies between the parts where the adhesive tapes are applied and the parts where the adhesive tapes are not applied. Since the distance between the flow passage plates differs depending on the positions of the flow passage plates, a gap is generated between the flow passage plates. Therefore, a fluid for heat exchange may leak through the gap between the flow passage plates.

The present disclosure has been made to solve the problem mentioned above, and an object thereof is to provide a heat exchange element and a heat exchange ventilation apparatus that reduce leakage of a fluid involved in heat exchange.

### Solution to Problem

In order to solve the above-described problems, the heat exchange element according to an embodiment of the present disclosure includes a plurality of a stack of flow passage plates each including a plurality of flow passage portions each serving as passages. The flow passage portions are joined together with an adhesive tape. The heat exchange element includes a gap adjustment unit having a thickness equal to or larger than a thickness of the adhesive tape, and configured to fill a gap between the passage plates.

### Advantageous Effects of Invention

According to the present disclosure, between the plurality of flow passage plates being stacked, the gap adjustment units are interposed in a thickness larger than the thickness of the adhesive tape for bonding the flow passage units, so as to eliminate the gap between the flow passage plate that can be formed by application of the adhesive tape. Therefore, it is possible to suppress the leakage of the fluid associated with the heat exchange from the space between the fluid passages associated with the heat exchange.

### BRIEF DESCRIPTION OF DRAWINGS

FIG. 1 illustrates a configuration of a transfer body 3 forming a heat exchange element 14 according to Embodiment 1 of the present disclosure.

FIG. 2 illustrates a configuration of a flow passage plate 4 in the heat exchange element 14 according to Embodiment 1 of the present disclosure.

FIG. 3 illustrates an entire configuration of the heat exchange element 14 according to Embodiment 1 of the present disclosure.

FIG. 4 illustrates a first flow passage 10 in the flow passage plate 4 according to Embodiment 1 of the present disclosure.

FIG. 5 illustrates a second flow passage 11 in the flow passage plate 4 according to Embodiment 1 of the present disclosure.

FIG. 6 illustrates a fluid flow in the heat exchange element 14 according to Embodiment 1 of the present disclosure.

FIG. 7 illustrates a configuration of the heat exchange element 14 according to Embodiment 2 of the present disclosure.

FIG. 8 illustrates a configuration of a modification example of the heat exchange element 14 according to the second embodiment of the present disclosure.

FIG. 9 illustrates a configuration of a modification example of the heat exchange element 14 according to Embodiment 2 of the present disclosure.

FIG. 10 schematically illustrates a configuration of a heat exchange ventilation apparatus 20 having the heat exchange element 14 according to Embodiment 4 of the present disclosure.

FIG. 11 illustrates an example of installation in a room of the heat exchange ventilation apparatus 20 having the heat exchange element 14 according to Embodiment 4 of the present disclosure.

### DESCRIPTION OF EMBODIMENTS

### Embodiment 1

Hereinafter, a preferred Embodiment of the heat exchange element of the present disclosure will be described with reference to the drawings. Here, the same or corresponding parts in each of the drawings will be described with the same reference signs. The disclosure is not restricted by the description in the Embodiments.

### Embodiment 1

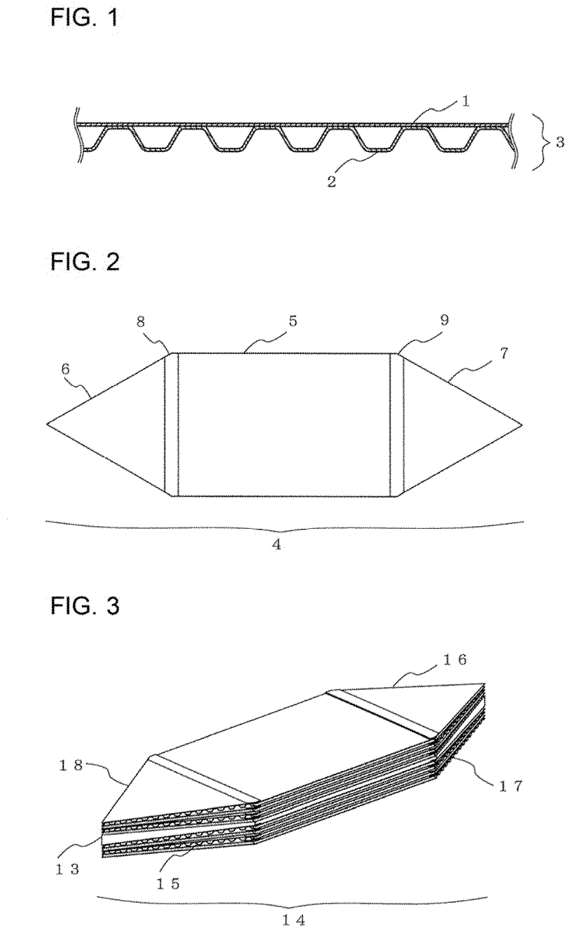

FIG. 1 is illustrates the structure of a heat transfer body 3 forming a heat exchange element 14 according to Embodiment 1 of the present disclosure. FIG. 2 illustrates the structure of a flow passage plate 4 of the heat exchange element 14 according to Embodiment 1 of the present disclosure. FIG. 3 illustrates the entire structure of the heat exchange element 14 according to Embodiment 1 of the present disclosure.

FIG. 1 illustrates the heat transfer body 3 forming the heat exchanging element 14 as viewed from the side. As illustrated in FIG. 1, the heat transfer body 3 has a partition plate 1 and a spacing plate 2. The partition plate 1 separates a fluid flowing along one plate side from a fluid flowing along the other plate side, and exchanges total heat between the two fluids. The partition plate 1 is made of thin paper or the like. The spacing plate 2 has a corrugated plate-like shape to hold the partition plate 1 in parallel with the spacing plate 2. The spacing plate 2 is made of cardboard or the like. Then, the corrugated crest portion and the partition plate 1 of the spacing plate 2 is joined so as to be in contact with each other, thereby forming the heat transfer body 3 in which a space surrounded by the partition plate 1 and the spacing plate 2 is served as a flow passage.

The partition plate 1 is formed of a material having heat conductivity and moisture permeability or a material having only heat conductivity. On the other hand, in order to retain the structure, it is desirable that, by deforming or by other methods, the spacing plate 2 have a shape-holding performance capable of holding its shape. Further, it is desired that the spacing plate 2 be thin, since, if it is thick, the spacing plate 2 blocks the flow passage, leading to an increase in pressure loss. Therefore, the partition plate 1 and the spacing plate 2 in Embodiment 1 are formed of a pulp material made of cellulose or the like, which satisfies the above-described properties. Here, when only conductivity is important, the partition plate 1 and the spacing plate 2 each may be made of a resin thin film, a metal thin film, or the like. Specific examples of the metal include aluminum, iron, and stainless steel. The spacing plate 2 has a substantially corrugated shape, to thereby form a space being sandwiched between the plurality of the partition plate 1. This substantially corrugated wave shape is obtained by sandwiching the base paper of the spacing plate 2 using a corrugating machine or a rack and a pinion or the like. The flat partition plate 1 is bonded to the crest portion of the spacing plate 2 having a substantially corrugated shape with an adhesive or the like to form a single-face corrugated heat transfer body 3. By bonding the partition plate 1 and the spacing plate 2, there is an effect of keeping the partition plate 1 having a low rigidity in a flat surface. In one heat transfer body 3, the end portion of the partition plate 1 and the substantially corrugated spacing plate 2 are matched, the spacing plate 2 is bonded with the entire partition plate 1. Here, the term “adhesive” includes a fluid-like sticky material or a filler material in a case where a filler material is dissolved and bonded in welding.

FIG. 2 schematically illustrates the flow passage plate 4 formed of the heat transfer body 3. The flow passage plate 4 includes a central flow passage unit 5, a first separated flow passage unit 6 and a second separated flow passage unit 7, which are formed by cutting the heat transfer body 3. In the flow passage plate 4, the end of the central flow passage unit 5 and the end of the first separated flow passage unit 6 abut on one side, and a first adhesive tape 8 is attached to the portion where the two ends abut, whereby the central flow passage unit 5 and the first separated flow passage unit 6 are bonded to each other. Similarly, the end of the central flow passage unit 5 and the end of the second separated flow passage unit 7 facing the end bonded to the first separated flow passage unit 6 abut on one side. A second adhesive tape 9 is attached to the portion where these ends abut, and the central flow passage unit 5 and the second separated flow passage unit 7 are bonded. Thus, the central flow passage unit 5 and the first separated flow passage unit 6 are bonded with the first adhesive tape 8, and the central flow passage unit 5 and the second separated flow passage unit 7 are bonded with the second adhesive tape 9, whereby the flow passage plate 4 is formed. Here, as for the flow passage plate 4, the attachment angle of the spacing plate 2 in the first separated flow passage unit 6 and the second separated flow passage unit 7 is determined by the attachment angle of the spacing plate 2 in the central flow passage unit 5. There are two types of flow passage plates 4 forming a pair, each having an angle inverted relative to the angle at which the spacing plate 5 is attached in the central flow passage unit 5.

FIG. 3 schematically illustrates the heat exchange element 14 formed of a plurality of layers (hereinafter referred to as a “stack”) obtained by stacking the flow passage plates 4. As shown in FIG. 3, when stacking a plurality of flow passage plates 4, two types of paired flow passage plates 4 are alternately bonded and stacked. Hereinafter, the flow passage plates 4 will be described as being stacked upward from the bottom to top in FIG. 3. As illustrated in FIG. 3, the two types of the flow passage plates 4 are alternately stacked, whereby the heat exchange element 14 having a first inflow port 15, a first outflow port 16, and a second inflow port 17, and a second outlet 18 is formed.

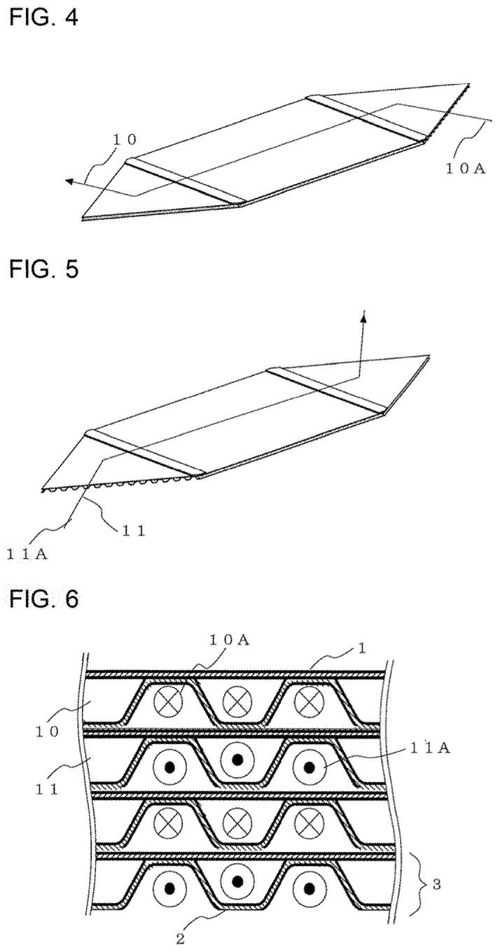

FIG. 4 illustrates the first flow passage 10 in the flow passage plate 4 according to Embodiment 1 of the present disclosure. FIG. 5 illustrates the second flow passage plate 11 in the flow passage plate 4 according to Embodiment 1 of the present disclosure. The spacing plate 2 is disposed between the partition plate 1 in one flow passage plate 4 and the partition plate 1 in another flow passage plate 1 that is paired with the one flow passage plate 4, thereby forming a space served as a flow passage. As shown by the arrow in FIG. 4, of the flow passage plates forming a pair, in one flow passage plate 4, a first flow passage 10 is formed. The first flow passage 10 is a passage that flows from a first separate flow passage unit 6 and leads to the second separated flow passage unit 7 via the central flow passage unit 5. Further, as shown by the arrow in FIG. 5, in the other flow passage plate 5, a second flow passage 11 is formed. The second flow passage 11 is a passage that flows from the second separated flow passage unit 7 and leads to the first separated flow passage unit 6 via the central flow passage unit 5. By allowing two fluids that exchange heat to flow alternately in each of the layers in the first flow passage 10 and the second flow passage 11, heat can be continuously exchanged through the partition plate 1.

When the plurality of flow passage plates 4 are stacked, distortion occurs due to the thickness of each of the first adhesive tape 8 and the second adhesive tape 9 in the flow passage plates, and as a result, a gap is formed. In order to suppress formation of such gap, as shown in FIG. 3, in the heat exchange element 14 of Embodiment 1, the gap adjustment unit 13 is disposed between the portions where the plurality of flow passage plates 4 are stacked, and is adhered to the flow passage plate 4. Here, the gap adjustment unit 13 may be disposed between the flow passage plates 4. Since the thickness of each of the first adhesive tape 8 and the second adhesive tape 9 is small, the gap adjustment unit 13 may be disposed between the two flow passage plates 4 in the central portion after stacking the plurality of layers.

Further, it is desirable that the gap adjustment unit 13 have an area that covers the entire flow passage plate 4 and have a shape that fills the space generated by distortion. Therefore, the gap adjustment unit 13 is thin at portions where the first adhesive tape 8 and the second adhesive tape 9 above the portions where the first separated passage unit 6 and the second separated passage unit 7 are joined with the central flow passage unit 5, respectively. The gap adjustment unit 13 located on the tape 9 has a small thickness. Then, as the distance from the first adhesive tape 8 and the second adhesive tape 9 increases, the thickness of the gap adjustment unit 13 increases. For this reason, the portion where the thickness of the gap adjustment unit 13 is largest has a thickness greater than or equal to the thicknesses of the first adhesive tape 8 and the second adhesive tape 9. By changing the thickness of the gap adjustment unit 13 depending on unevenness created by the location of the flow passage plate 4, the space formed by the unevenness can be filled.

Here, materials for forming the space-forming material 13 include an adhesive such as ethylene vinyl acetate (EVA), an acrylic resin, or a cellulose-based resin. However, the material of the gap adjustment unit 13 is not limited to these. For example, an adhesive having flexibility, elasticity, or the like, such as silicone, rubber-based resin, or the like, may be used. Further, a sponge material and a rubber material may be used as a material of the gap adjustment unit 13, and the gap adjustment unit 13 may be used after applying an adhesive thereto. Since the gap generated in the heat exchange element 14 by distortion does not have a constant shape, when the gap adjustment unit 13 is a rigid material, it is difficult to fill the gap. Since the gap adjustment unit 13 has flexibility, elasticity, and the like, the gap adjustment unit 13 is brought into close contact with the flow passage plate 4, the first adhesive tape 8, and the second adhesive tape 9, thereby making it easy to fill a gap generated in the heat exchange element 14. Further, a heat-conductive filler such as carbon fibers or alumina particles may be added to a material such as an adhesive, a sponge material, or a rubber material and mixed to form the gap adjustment unit 13. The heat transfer filler, by increasing the heat transfer of the gap adjustment unit 13, it is possible to promote heat exchange between the fluid flowing through the flow passage plate 4 through the gap adjustment unit 13.

Here, with respect to the flexibility and elasticity of the gap adjustment unit 13, the deformation stress of the gap adjustment unit 13 is smaller than the stress to deform the material forming the flow passage plate 4. For example, when the fluid flows through the flow passage plate 4, in the flow passage plate 4, the space between the partition plates 1 may be expanded and deformed by the pressure of the fluid. Since the gap adjustment unit 13 has flexibility and elasticity, expansion deformation between the partition plates 1 is reduced. In addition, the gap adjustment unit 13 blocks the fluid so as not to allow the fluid to pass therethrough. Therefore, the gap adjustment unit 13 fills the gap formed by stacking the flow passage plates 4, thereby preventing leakage of the fluid through the gap adjustment unit 13.

Here, although the gap adjustment unit 13 has an area covering the entire flow passage plate 4, the gap adjustment unit 13 may be disposed on the first separated flow passage unit 6 and the second separated flow passage unit 7 without covering the central flow passage unit 5 of the flow passage plate 4. The gap adjustment unit 13 may be integrated with at least one of the partition plate 1 and the spacing plate 2 of the flow passage plate 4. At least one of the partition plate 1 and the spacing plate 2 may have a thickness equal to or greater than that of the first adhesive tape 8 and the second adhesive tape 9, and may have flexibility, elasticity, or the like.

As described above, the heat exchange element 14 having the gap adjustment unit 13 is formed. As described above, the heat exchange element 14 causes heat exchange to be performed by passing outdoor air and indoor air through the internal passages. When causing heat exchange to be performed, the heat exchange element 14 is required to be provided with a flow passage through which outdoor air is introduced into a room and a flow passage through which indoor air is exhausted from the room. Hereinafter, the air flowing into the room from the outdoor space is referred to as a first fluid 10A. The first fluid 10A passes through the first flow passage 10. Air flowing out from the room to the outdoor space is referred to as a second fluid 11A. The second fluid 11 A passes through the second flow passage 11.

Here, the first fluid 10A flows in from the first inflow port 15 and flows out from the first outflow port 16. On the other hand, the second fluid 11A flows in from the second inflow port 17 and flows out from the second outflow port 18. In Embodiment 1, the first inflow port 15 and the second inflow port 17 are arranged on opposite sides of the central flow passage unit 5.

FIG. 6 illustrates the flow of a fluid in the heat exchange element 14 according to Embodiment 1 of the present disclosure. FIG. 6 shows a part of a portion obtained by cutting the stacked flow passage plates 4. In the central flow passage unit 5, the first fluid 10A and the second fluid 11A flow in opposite directions. As shown in FIG. 6, the first fluid 10A passing through the first flow passage 10 flows from a near side to a far side of the sheet. On the other hand, the second fluid 11A passing through the second flow passage 11 flows from the far side to the near side of the sheet. In this way, the fluids flow in opposite directions through the individual flow passage plate 4, and total heat exchange is performed via the partition plate 1. Therefore, the heat exchange element 14 can achieve a high total heat exchange efficiency.

As described above, according to the heat exchange element 14 of Embodiment 1, the gap adjustment unit 13 having a thickness equal to or greater than those of the first adhesive tape 8 and the second adhesive tape 9 is arranged, whereby the gap between the flow passage plates 4 is eliminated. Since the gap is eliminated, it is possible to suppress the leakage of the fluid involved in heat exchange from a gap between the flow passage plates 4. At this time, by changing the thickness of the gap adjustment unit 13 in accordance with the unevenness generated depending on the location of the flow passage plate 4, the gap generated by the unevenness can be filled. In addition, in the heat exchange element 14 of Embodiment 1, by using paper as the material of the flow passage plate 4, the first fluid 10A and the second fluid 11A can be exchanged not only in temperature but also in humidity. Further, since the gap adjustment unit 13 has flexibility and elasticity, the adhesion between the gap adjustment unit 13 and the flow passage plate 4 is increased, and it becomes easy to fill the gap generated in the heat exchange element 14. Here, by using a material containing an adhesive as the gap adjustment unit 13, the adhesiveness between the gap adjustment unit 13 and the flow passage plate 4 can be improved. Further, by mixing the heat conductive filler, the heat conductivity of the gap adjustment unit 13 can be enhanced.

### Embodiment 2

Here, the heat exchange element 14 according to Embodiment 2 will be described. The heat exchange element 14 according to Embodiment 2 has basically the same configuration as the heat exchange element 14 according to Embodiment 1. It differs from the heat exchange element 14 of Embodiment 1 in that the gap adjustment unit 13 has a different shape and a heat transfer material 19 is applied.

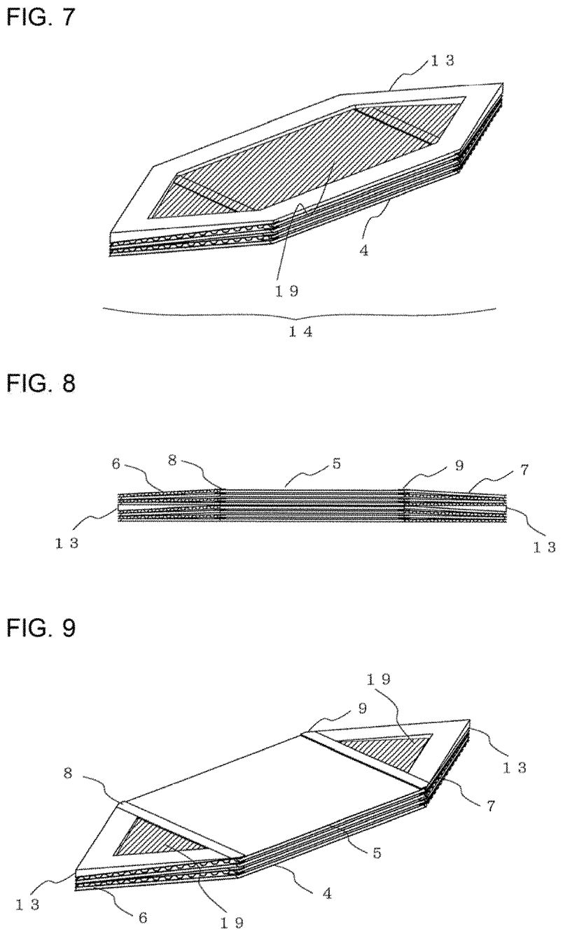

FIG. 7 illustrates a configuration of the heat exchange element according to Embodiment 2. The central portion of the gap adjustment unit 13 disposed between the stacked flow passage plates 4 has a hollow shape with a hole. The gap adjustment unit 13 is attached to a peripheral edge portion of the flow passage plate 4. By attaching the gap adjustment unit 13 with the hole to the central portion, a tub-like space surrounded by the upper surface of the flow passage plate 4 and the gap adjustment unit 13 is formed.

Further, in the heat exchange element 14 of Embodiment 2, a heat transfer material 19 having a higher heat transferability than the gap adjustment unit 13 is applied. As the heat transfer material 19, a heat dissipating grease, a heat conductive gel made of silicone, or the like, is used. The heat dissipating grease and the heat conductive gel serving as the heat transfer material 19 has fluidity, although being excellent in adhesiveness and thermal conductivity. Therefore, even if it is uniformly applied, the heat transfer material 19 may be moved during long-term use. By applying the heat transfer material 19 into the tub-shaped space like the heat exchanger elements 14 of Embodiment 2, the heat transfer material 19 can be retained between the flow passage plates 4. As a result, through the heat transfer material 19, it is possible to promote the heat exchange between the respective fluids flowing through the two flow passage plates 4. Here, the gap adjustment unit 13 needs not be a single portion, and plurality of portions may be combined to form a tub-shaped space surrounded by the gap adjustment unit 13 and the upper surface of the flow passage plate 4.

### Modification Example

In the heat exchange element 14 described above, the gap adjustment unit 13 is attached to the entire peripheral edge portion of the flow passage plate 4. Here, as a modification example of the heat exchange element 14, the gap adjustment unit 13 is arranged only on the first separated flow passage unit 6 and the second separated flow passage unit 7 of the flow passage plate 4. The gap adjustment unit 13 has a notch.

FIGS. 8 and 9 each illustrate a configuration of a modification of the heat exchange element 14 according to Embodiment 2 of the present disclosure. FIG. 8 is a side view of the heat exchange element 14. In addition, FIG. 9 illustrates the gap adjustment unit 13 in the modification example. As illustrated in FIG. 9, the notches are provided in the directions of the first adhesive tape 8 and the second adhesive tape 9, respectively. By stacking the flow passage plates 4, distortion is generated due to the thicknesses of the first adhesive tape 8 and the second adhesive tape 9. Therefore, relative to the bonding position of the first adhesive tape 8 and the second adhesive tape 9, the first separated flow passage unit 6 and the second separated flow passage unit 7 of the flow passage plate 4 are inclined in a larger degree as the distance from the bonding positions is increased.

On the other hand, the thickness of the gap adjustment unit 13 is increased as the distance from the bonding position is increased. At a position where the gap adjustment unit 13 is thickest, the thickness thereof is greater than or equal to the thicknesses of the first adhesive tape 8 and the second adhesive tape 9. Therefore, on each of the first separated flow passage unit 6 and the second separated flow channel unit 7 of the flow passage plate 4, trough-shaped spaces are defined by the first adhesive tape 8, the second adhesive tape 9, the gap adjustment unit 13 and the upper surfaces of the first separated flow passage unit 6 and the second separated flow passage unit 7.

The heat transfer material 19 is applied to the trough-shaped space. As a result, heat exchange between the fluids flowing in the flow passage plates 4 in the upper and lower layers with the heat transfer material 19 interposed therebetween is promoted. Here, the gap adjustment unit 13 does not necessarily be a single portion, and may be formed of a combination of a plurality of portions, and the trough-shaped spaces may be defined by the upper surfaces of the flow passage plate 4, the first adhesive tape 8 and the second adhesive tape 9.

As described above, according to the heat exchange element 14 of Embodiment 2, the gap adjustment unit 13 is installed in a part between the flow passage plates 4 and the heat transfer material 19 is applied, whereby the heat transfer material 19 having higher heat transferability than the gap adjustment unit 13 can be interposed without intervention of the gap adjustment unit 13. As a result, a part where the two flow passage plates 14 face to each other can be provided, whereby heat exchange efficiency can be improved.

### Embodiment 3

Here, the heat exchange element 14 according to Embodiment 3 will be described. The heat exchange element 14 according to Embodiment 3 has basically the same configuration as the heat exchange element 14 according to Embodiment 1. The heat exchange element 14 of Embodiment 3 is different from the heat exchange element 14 of Embodiment 1 in that a material having a thermal foaming property is used as the gap adjustment unit 13 arranged between the flow passage plates 4. Here, as a material having a thermal foaming property, a thermal foaming paint in which a foaming agent is added to a paint or a thermal foaming adhesive in which a foaming agent is added to an adhesive can be given. Examples of the foaming agent include thermally expandable hollow elastic microspheres, an inorganic foaming agent, a nitroso-based foaming agent, an azo-based foaming agent, and a sulfonylhydrazide-based foaming agent. Since it is necessary to balance an adhesive area, an impact resistance, a shear adhesive strength, an expansion ratio at the time of foaming and curing is 1.2 to 5 times, preferably 1.5 to 3 times.

When stacking the flow passage plates 4, a thermal foaming paint or a thermal foaming adhesive having a thermal foaming property is applied to spaces between the flow passage plates 4 on which the gap adjustment unit 13 is installed, thereby to allow the flow passage plates 4 to be adhered with one another. Then, by applying heat to the flow passage plate 4, thermal foaming occurs, and the volume thereof expands, whereby the gap adjustment unit 13 is formed. At this time, due to the volume expansion of the gap adjustment unit 13, the gap adjustment unit 13 spreads between the flow passage plates 4. As a result, the space between the flow passage plates 4 can be filled.

The gap formed by stacking the flow passage plates 4 varies depending on the stacked state. For this reason, it is desirable to allow the thermal foaming paint or the thermal foaming adhesive, which serves as the gap adjustment unit 13, to be applied after the amount being adjusted appropriately instead of being set to a fixed value. Further, it is desirable that the thermal foaming paint or the thermal foaming adhesive be applied to the edge portions instead of the entire surface of the flow passage plate 4 so that the center portion of the formed gap adjustment unit 13 becomes hollow. When the volume is expanded by applying heat to the thermal foaming paint or the thermal foaming adhesive, if the volume expands to a level larger than that is enough to fill the gap between the flow passage plates 4, a pressure due to the expansion is applied to the flow passage plate 4 and the flow passage plate 4 may be deformed to block the air passage. By applying the thermal foaming paint or the thermal foaming adhesive to edge portions of the flow passage plate 4 while adjusting the amount to be applied, it is possible to suppress an excessive increase in volume of the gap adjustment unit 13. Even if the thermally foaming paint or the thermally foaming adhesive is excessively foamed and the volume increases, the part corresponding to the increase in the volume spreads into the hollow. Therefore, the force applied to the flow passage plates 4 is relieved and the deformation of the passage plates 4 can be prevented.

As described above, according to the heat exchange element 14 of Embodiment 3, the gap adjustment unit 13 is made of a material containing a foaming agent, so that the space is filled by thermal forming according to the shape of the flow passage plate 4.

### Embodiment 4

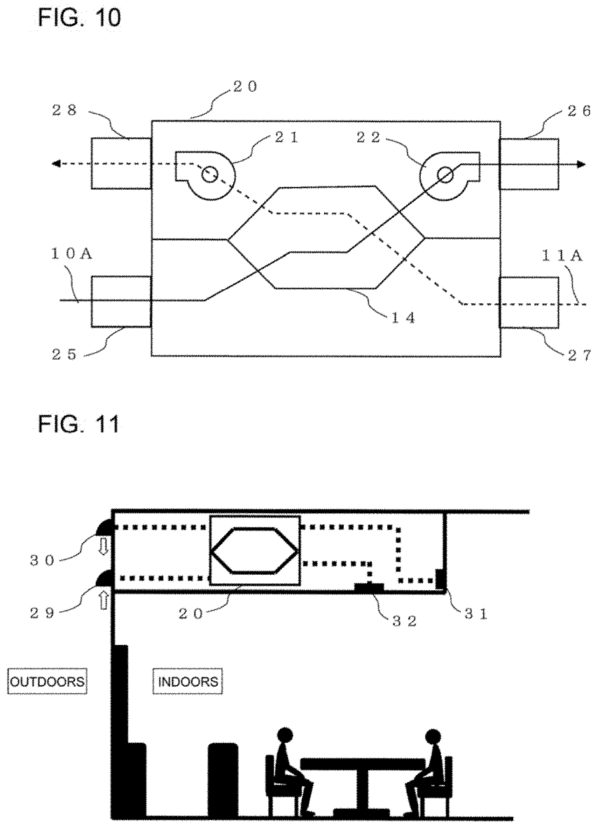

FIG. 10 schematically illustrates a configuration of the heat exchange ventilation apparatus 20 having the heat exchange element 14 according to Embodiment 4 of the present disclosure. As illustrated in FIG. 10, the heat exchange element 14 is mounted in the heat exchange ventilation apparatus 20. In the heat exchange ventilation apparatus 20, heat exchange is performed by causing indoor air and outdoor air to pass through the heat exchange element 14. An exhaust fan 21 and an air supply fan 22 are mounted inside the heat exchange ventilation apparatus 20. The exhaust fan 21 sends the second fluid 11A from the indoor space to the outdoor space. Further, the air supply fan 22 sends the first fluid 10A from the outdoor space to the indoor space. An outside air duct 25 is connected to the first inflow port 15 of the heat exchange element 14. Further, an air supply duct 26 is connected to the first outlet 16 of the heat exchange element 14. Furthermore, a return air duct 27 is connected to the second inlet 17 of the heat exchange element 14. The exhaust duct 28 is connected to the second outlet 18 of the heat exchange element 14.

When the air supply fan 22 is driven, the first fluid 10A flows in from the outside air duct 25, passes through the heat exchange element 14, and flows into a room from the air supply duct 26. When the exhaust fan 21 is driven, the second fluid 11A flows in from the return air duct 27, passes through the heat exchange element 14, and flows out of the room through the exhaust duct 28. The first fluid 10A and the second fluid 11A form counterflows in the central flow passage unit 5 of the heat exchange element 14, so that the total heat is exchanged and the heat exchange can be efficiently performed.

FIG. 11 illustrates an example of installation in the room of the heat exchange ventilation apparatus 20 which has the heat exchange element 14 according to Embodiment 4 of the present disclosure. The heat exchange ventilation apparatus 20 is one type of air-conditioning apparatus, and has a ventilation function of supplying outdoor air to the room and exhausting indoor air to the outdoor space. Further, the heat exchange ventilation apparatus 20 has a function of recovering heat from discharged air and supplying the heat to supplied air, thereby reducing an energy load on an air-conditioning device or other devices configured to control the indoor temperature.

The heat exchange ventilation apparatus 20 according to Embodiment 4 is accommodated in a space above a ceiling of the room. As illustrated in FIG. 11, from the viewpoint of aesthetic design, there are many rooms where air-conditioning-related devices are collectively accommodated in the space above the ceiling. When the devices are installed in the space above the ceiling, generally, a large installation space can be secured as compared with the case where the device is installed in the room.

In FIG. 11, on the outdoor wall surface, an outdoor intake port 29 which is a hole for taking in outdoor air to the outdoor wall surface and an outdoor exhaust port 30 which is a hole for exhausting air to the outdoor room are provided, and on the ceiling of the room, an air supply port 31 which is a hole for allowing air to flow into the indoor ceiling and an indoor exhaust port 32 which is a hole for exhausting indoor air are provided. The outdoor intake port 29 is connected to the outdoor air duct 25, the indoor air supply port 31 is connected to the air supply duct 26, the indoor exhaust port 32 is connected to the return air duct 27, and the outdoor exhaust port 30 and the exhaust duct 28 are connected.

### REFERENCE SIGNS LIST

1 partition plate 2 spacing plate 3 heat transfer body 4 flow passage plate 5 central flow passage unit 6 first separated flow passage unit 7 second separated flow passage unit 8 first adhesive tape 9 second adhesive tape 10 first flow passage 10A first fluid 11 second flow passage 11A second fluid 13 gap adjustment unit 14 heat exchange element first inflow port 16 first outlet 17 second inlet 18 second outlet 19 heat transfer material 20 heat exchange ventilation apparatus 21 exhaust fan 22 air supply fan 25 outside air duct 26 air supply duct 27 return air duct 28 exhaust duct 29 outdoor intake port outdoor exhaust port 31 indoor air supply port 32 indoor exhaust port

1. A heat exchange element comprising:
portions each include a plurality of layers obtained by stacking a plurality of flow passage plates each comprising a plurality of passage portions serving as flow passages, the passage portions being bonded to each other with an adhesive tape;
a gap adjustment unit having a thickness equal to or larger than a thickness of an adhesive tape and is configured to fill a gap between two of the portions adjacent to each other, and
the flow passage plates include a central passage portion, a first separated passage portion and a second separated flow passage portion.

2. The heat exchange element according to claim 1, wherein the gap adjustment unit has a thickness depending on unevenness of the flow passage plates.

3. The heat exchange element according to claim 1, wherein each of the flow passage plates is made of paper.

4. The heat exchange element of claim 1, wherein the gap adjustment unit has at least one of flexibility and elasticity.

5. The heat exchange element of claim 1, wherein the gap adjustment unit has adhesiveness.

6. The heat exchange element of claim 5, wherein the gap adjustment unit has thermal foaming property.

7. The heat exchange element of claim 1, wherein the gap adjustment unit comprises a thermal conductive filler added thereto.

8. The heat exchange element of claim 1, wherein the gap adjustment unit is disposed at a part between the flow passage plates, and a part of the flow passage plates where no gap adjustment unit is provided comprises a heat transfer material.

9. The heat exchange element of claim 1, wherein the gap adjustment unit is made of a material configured not to allow a fluid to pass through the gap adjustment unit.

10. The heat exchange element of claim 1,
wherein the flow passage portions comprise a central passage portion, a first separated passage portion, and a second separated passage portion,
wherein the central passage portion and the first separated passage portion are bonded to each other with a first tape of the adhesive tape,
wherein the central passage portion and the second separated passage portion are bonded to each other with a second tape of the adhesive tape.

11. A heat exchange ventilation apparatus comprising the heat exchange element of claim 1.
